(19) United States
(12) Patent Application Publication
(10) Pub. No.: US 2022/0236065 A1
(43) Pub. Date: Jul. 28, 2022

(54) MAP DATA FUSION METHOD AND APPARATUS, ELECTRONIC DEVICE, MEDIUM AND PROGRAM PRODUCT

(71) Applicant: Apollo Intelligent Driving Technology (Beijing) Co., Ltd., Beijing (CN)

(72) Inventors: Qisheng LIU, Beijing (CN); Youhao LI, Beijing (CN); Songtao CHANG, Beijing (CN); Cheng LUO, Beijing (CN)

(21) Appl. No.: 17/721,628

(22) Filed: Apr. 15, 2022

(30) Foreign Application Priority Data
Jul. 13, 2021 (CN) 202110790517.5

(51) Int. Cl. G01C 21/32; G01C 21/00

(52) U.S. Cl. CPC G01C 21/32; G01C 21/387; G01C 21/3867; G01C 21/3833

(57) ABSTRACT

The present disclosure provides a map data fusion method and apparatus, an electronic device, a medium and a program product. The method includes: acquiring first map data and second map data; based on a first feature descriptor set and a second feature descriptor set included in the first map data and the second map data respectively, determining a set of matching point pairs between a first set of three-dimensional coordinate points and a second set of three-dimensional coordinate points included in the first map data and the second map data respectively; determining a pose transformation matrix between the first map data and the second map data based on the set of matching point pairs; and fusing the first map data and the second map data into third map data based on the pose transformation matrix.

### CROSS-REFERENCE TO RELATED APPLICATIONS

This application claims priority to Chinese Patent Application No. 202110790517.5, filed with the China National Intellectual Property Administration (CNIPA) on Jul. 13, 2021, the contents of which are incorporated herein by reference in their entirety.

### TECHNICAL FIELD

The present disclosure relates to the field of computers, in particular to the fields of map drawing and autonomous driving, can be applied to assisted driving and autonomous driving scenarios, and more particularly, relates to a map data fusion method, a map data fusion apparatus, an electronic device, a computer-readable storage medium and a computer program product.

### BACKGROUND

For assisted driving or autonomous driving applications that provide an autonomous parking function, the pose of a vehicle is calculated in real time based on a parking lot map constructed in advance. However, the parking lot environment may change slowly over time, especially in outdoor parking lots. Different weathers or different lighting conditions at different time of the same day may also cause the map to be less reliable or invalid, so that the reliability of the constructed map decreases. Therefore, sensor data may be collected when a user passes through a mapping region, and the map is fused and updated using the collected sensor data, so that the map can automatically adapt to changes in a scenario, and then the available time of the route map can be extended.

### SUMMARY

According to the embodiments of the present disclosure, a map data fusion method, a map data fusion apparatus, an electronic device, a computer-readable storage medium and a computer program product are provided.

In a first aspect, embodiments of the present disclosure provide a map data fusion method, comprising: acquiring first map data, the first map data comprising a first set of three-dimensional coordinate points and a first feature descriptor set associated with the first set of three-dimensional coordinate points; acquiring second map data, the second map data comprising a second set of three-dimensional coordinate points and a second feature descriptor set associated with the second set of three-dimensional coordinate points, and the first map data and the second map data being for the same map; determining, based on the first feature descriptor set and the second feature descriptor set, a set of matching point pairs between the first set of three-dimensional coordinate points and the second set of three-dimensional coordinate points; determining a pose transformation matrix between the first map data and the second map data based on the set of matching point pairs; and fusing the first map data and the second map data into third map data based on the pose transformation matrix.

In a second aspect, embodiments of the present disclosure provide a map data fusion apparatus, comprising: a first map data acquisition module, configured to acquire first map data, the first map data comprising a first set of three-dimensional coordinate points and a first feature descriptor set associated with the first set of three-dimensional coordinate points; a second map data acquisition module, configured to acquire second map data, the second map data comprising a second set of three-dimensional coordinate points and a second feature descriptor set associated with the second set of three-dimensional coordinate points, and the first map data and the second map data being for the same map; a matching point pair set determination module, configured to determine, based on the first feature descriptor set and the second feature descriptor set, a set of matching point pairs between the first set of three-dimensional coordinate points and the second set of three-dimensional coordinate points; a first pose transformation matrix determination module, configured to determine a pose transformation matrix between the first map data and the second map data based on the set of matching point pairs; and a map data fusion module, configured to fuse the first map data and the second map data into third map data based on the pose transformation matrix.

In a third aspect, embodiments of the present disclosure provide an electronic device, comprising: one or more processors; and a memory, storing one or more programs, wherein the one or more programs, when executed by the one or more processors, cause the one or more processors to implement the method provided by the first aspect.

In a fourth aspect, embodiments of the present disclosure provide a computer-readable medium, storing a computer program thereon, wherein the program, when executed by a processor, causes the processor to implement the method provided by the first aspect.

In a fifth aspect, an embodiment of the present disclosure provides a computer program product, comprising a computer program, wherein the computer program, when executed by a processor, implements the method provided by the first aspect.

It should be appreciated that the description of the summary is not intended to limit the key or important features of the embodiments of the present disclosure, or to limit the scope of the present disclosure. Other features of the present disclosure will become readily comprehensible through the following description.

### BRIEF DESCRIPTION OF THE DRAWINGS

The above and other objectives, features and advantages of the present disclosure will become more apparent from more detailed descriptions of exemplary embodiments of the present disclosure with reference to the accompanying drawings. Like reference numerals in the exemplary embodiments of the present disclosure generally refer to the same components. It should be understood that the accompanying drawings are used for better understanding of this solution and do not constitute limitations to the present disclosure.

FIG. 1 shows a schematic block diagram of a map data fusion environment 100 in which a map data fusion method in some embodiments of the present disclosure can be implemented;

FIG. 2 shows a flowchart of a map data fusion method 200 according to an embodiment of the present disclosure;

FIG. 3 shows a flowchart of a map data fusion method 300 according to an embodiment of the present disclosure;

FIG. 4 shows a schematic block diagram of a map data fusion apparatus 400 according to an embodiment of the present disclosure; and

FIG. 5 shows a schematic block diagram of an exemplary electronic device 500 that can be used to implement the embodiments of the present disclosure.

In the drawings, the same or corresponding reference numerals indicate the same or corresponding parts.

### DETAILED DESCRIPTION OF EMBODIMENTS

Preferred embodiments of the present disclosure will be described in more detail below with reference to the accompanying drawings. Although the preferred embodiments of the present disclosure are shown in the drawings, it should be understood that the present disclosure can be implemented in various forms and should not be limited by the embodiments set forth herein. On the contrary, these embodiments are provided so that the present disclosure is more thorough and complete, and can fully convey the scope of the present disclosure to those skilled in the art.

As used herein, the term “include” and variations thereof represent open-ended inclusion, i.e., “include but not limited to”. The term “or” represents “and/or”, unless otherwise specified. The term “based on” represents “based at least in part on”. The terms “one exemplary embodiment” and “one embodiment” represent “at least one exemplary embodiment”. The term “another embodiment” represents “at least one additional embodiment”. The terms “first”, “second” and the like may indicate different or identical objects. Other explicit and implicit definitions may also be included below.

As described above in the background, the traditional technology for map data fusion requires more computing resources, and the fusion speed is not ideal.

In order to at least partially solve one or more of the above problems and other potential problems, an embodiment of the present disclosure provides a map data fusion method. Using the technical solution of the method, map data can be quickly fused without mass computing resources, so that not only can computing resources be saved, but also user experience of users who need to use the fused map data can be improved.

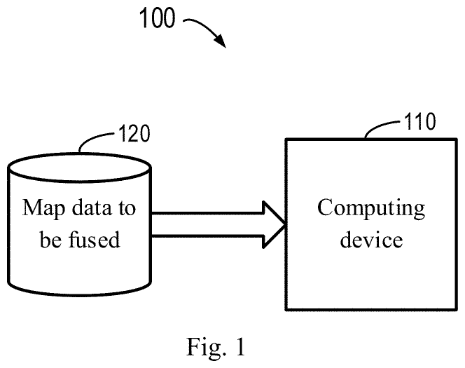

FIG. 1 shows a schematic block diagram of a map data fusion environment 100 in which a map data fusion method in some embodiments of the present disclosure can be implemented. According to one or more embodiments of the present disclosure, the map data fusion environment 100 may be a cloud environment. As shown in FIG. 1, the map data fusion environment 100 includes a computing device 110. In the map data fusion environment 100, map data to be fused 120 is provided to the computing device 110 as input to the computing device 110. The map data to be fused 120 may include, for example, first map data and second map data. The first map data may include, for example, a first set of three-dimensional coordinate points and a first feature descriptor set associated with the first set of three-dimensional coordinate points. The second map data includes a second set of three-dimensional coordinate points and a second feature descriptor set associated with the second set of three-dimensional coordinate points.

According to one or more embodiments of the present disclosure, a set of three-dimensional coordinate points, which may also be referred to as a point cloud, such as the first set of three-dimensional coordinate points and the second set of three-dimensional coordinate points, may be a set of points with three-dimensional coordinates, where the three-dimensional coordinates of the points may be, for example, world coordinates in the form of (x, y, z).

According to one or more embodiments of the present disclosure, a feature descriptor set such as the first feature descriptor set and the second feature descriptor set includes feature descriptors, where the feature descriptors may be in the form of multi-dimensional vectors. The feature descriptors come from feature points in images captured by an image capture device. The feature points are local features of the images, remain unchanged to rotation, size scaling, and brightness changes, and maintain a certain degree of stability to viewing angle changes, affine transformations, and noise. The feature descriptor set may be obtained by extracting features from captured images in a set of captured images using a feature extraction algorithm such as SIFT, SUPERPOINT, or ORB. Because the feature points in the captured images have corresponding feature descriptors, the three-dimensional coordinate points in the set of three-dimensional coordinate points included in the map data for constructing a map using the set of captured images will inherit the feature descriptors of the corresponding feature points in the set of captured images.

According to one or more embodiments of the present disclosure, the first map data and the second map data are for the same three-dimensional map. For example, the first map data and the second map data may both be map data for a three-dimensional map of the same parking lot scenario.

According to one or more embodiments of the present disclosure, the first map data may be map data constructed based on the latest set of captured images acquired through one trip, and the second map data may be map data of an existing map, where the second map data may be map data formed after multiple times of map data fusion and having a much larger data volume than the first map data.

After the map data to be fused 120 as input is acquired, the computing device 110 can, based on the feature descriptor set included in the map data to be fused 120, fuse the map data to be fused 120 by operations such as determining a set of matching point pairs and determining a pose transformation matrix to obtain fused map data, and can output the fused map data.

It should be understood that the map data fusion environment 100 is merely exemplary but not restrictive and is extensible in that more computing devices 110 may be included, and more map data to be fused 120 may be provided to the computing devices 110 as input, so as to meet the requirements of more users using more computing devices 110 at the same time, or even using more map data to be fused 120 to perform map data fusion operations at the same time or different time.

In the map data fusion environment 100 shown in FIG. 1, the operation of inputting the map data to be fused 120 to the computing device 110 may be performed through a network. Meanwhile, because the map data fusion method according to the embodiment of the present disclosure has a fast processing speed and requires few computing resources, the computing device 110 may also be, for example, a vehicle-mounted computing unit.

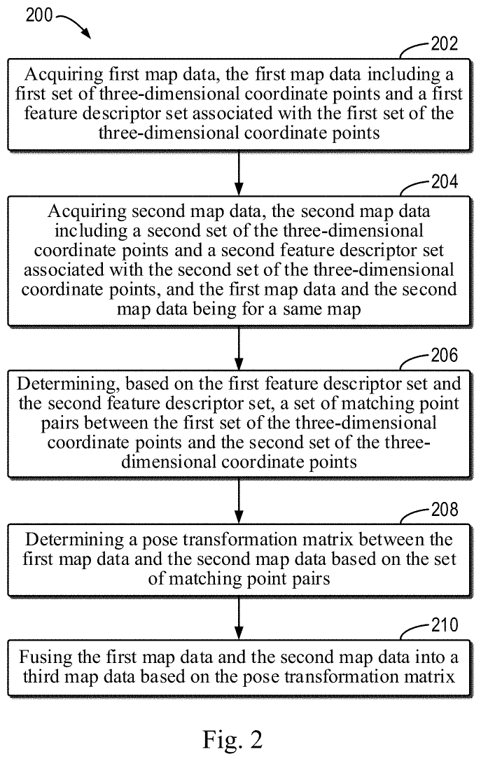

FIG. 2 shows a flowchart of a map data fusion method 200 according to an embodiment of the present disclosure. Specifically, the map data fusion method 200 may be performed by the computing device 110 in the map data fusion environment 100 shown in FIG. 1. It should be understood that the map data fusion method 200 may also include additional operations not shown and/or omit the operations shown, and the scope of the present disclosure is not limited thereto.

At block 202, the computing device 110 acquires first map data. According to one or more embodiments of the present disclosure, the first map data includes a first set of three-dimensional coordinate points and a first feature descriptor set associated with the first set of three-dimensional coordinate points.

According to one or more embodiments of the present disclosure, the computing device 110 may first acquire a first set of images captured by an image capture device for a scenario for which map data needs to be constructed. Then, the computing device 110 may perform feature extraction on the first captured image set by using a feature extraction algorithm such as SIFT, SUPERPOINT, or ORB, to obtain a first feature point set having the first feature descriptor set. Finally, the computing device 110 may determine the first set of three-dimensional coordinate points based on the first feature point set, where the three-dimensional coordinate points in the first set of three-dimensional coordinate points are associated with corresponding feature descriptors.

At block 204, the computing device 110 acquires second map data. According to one or more embodiments of the present disclosure, the second map data includes a second set of three-dimensional coordinate points and a second feature descriptor set associated with the second set of three-dimensional coordinate points, and the first map data and the second map data are for the same three-dimensional map. In some embodiments, the specific content of acquiring the second map data is similar to that of acquiring the first map data. In other embodiments, the second map data may be map data that has been formed by multiple times of map data fusion and has a much larger data volume than the first map data.

At block 206, the computing device 110 determines, based on the first feature descriptor set and the second feature descriptor set, a set of matching point pairs between the first set of three-dimensional coordinate points and the second set of three-dimensional coordinate points.

According to one or more embodiments of the present disclosure, the computing device 110 may first, for a first three-dimensional coordinate point in the first set of three-dimensional coordinate points, based on a first feature descriptor associated with the first three-dimensional coordinate point in the first feature descriptor set and the second feature descriptor set, determine a second feature descriptor closest to the first feature descriptor in the second set of three-dimensional coordinate points. As mentioned earlier, the feature descriptors may be in the form of multi-dimensional vectors, so the similarity between two feature descriptors can be determined by the distance between the two feature descriptors, where if the distance between the two feature descriptors is shorter, the similarity between the two feature descriptors is higher.

Then, the computing device 110 may determine whether the distance between the first feature descriptor and the second feature descriptor is less than a preset first threshold distance, and determine the point pair associated with the first feature descriptor and the second feature descriptor as a matching point pair in the set of matching point pairs when the distance between the first feature descriptor and the second feature descriptor is less than the preset first threshold distance.

According to one or more embodiments of the present disclosure, the first three-dimensional coordinate point in the first set of three-dimensional coordinate points may refer to any point in the first set of three-dimensional coordinate points, and the second three-dimensional coordinate point in the second set of three-dimensional coordinate points may also refer to any point in the second set of three-dimensional coordinate points.

When determining the set of matching point pairs between the first set of three-dimensional coordinate points and the second set of three-dimensional coordinate points, the computing device 110 may, for each point in the first set of three-dimensional coordinate points, search for a matching three-dimensional coordinate point in the second set of three-dimensional coordinate points to form a matching point pair, and the matching point pairs formed for all points in the first set of three-dimensional coordinate points constitute the set of matching point pairs. In some embodiments, only a few points in the first set of three-dimensional coordinate points can form matching point pairs with three-dimensional coordinate points in the second set of three-dimensional coordinate points.

According to one or more embodiments of the present disclosure, the two three-dimensional coordinate points included in the matching point pair may be preliminarily regarded as the same three-dimensional coordinate point in the physical world.

At block 208, the computing device 110 determines a pose transformation matrix between the first map data and the second map data based on the set of matching point pairs determined at block 206. According to one or more embodiments of the present disclosure, the pose transformation matrix between the first map data and the second map data may refer to a pose transformation matrix between the first set of three-dimensional coordinate points and the second set of three-dimensional coordinate points, and the computing device 110 may determine the pose transformation matrix based on the set of matching point pairs by using a random sample consensus iterative closest point (RANSAC ICP) algorithm.

At block 210, the computing device 110 fuses the first map data and the second map data into third map data based on the pose transformation matrix determined at block 208, where the third map data may include a third set of three-dimensional coordinate points and a third feature descriptor set associated with the third set of three-dimensional coordinate points. According to one or more embodiments of the present disclosure, the computing device 110 may convert the three-dimensional coordinates of each point in the first set of three-dimensional coordinate points into corresponding three-dimensional coordinates in the second set of three-dimensional coordinate points, and then fuse the point to the second set of three-dimensional coordinate points, to fuse the first map data and the second map data into the third map data.

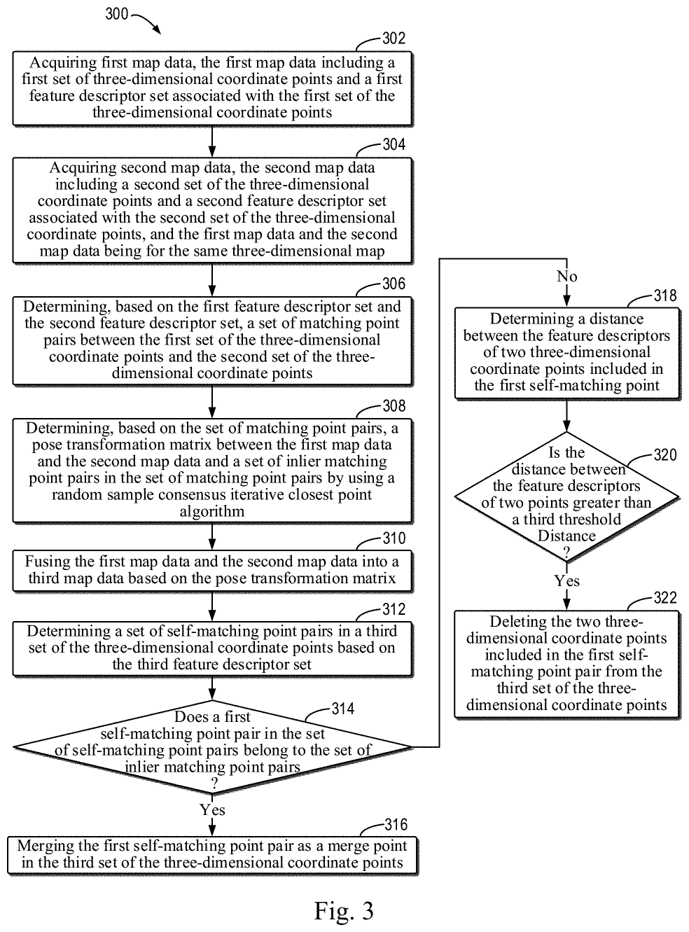

FIG. 3 shows a flowchart of a map data fusion method 300 according to an embodiment of the present disclosure. Specifically, the map data fusion method 300 may also be executed by the computing device 110 in the map data fusion environment 100 shown in FIG. 1. It should be understood that the map data fusion method 300 may also include additional operations not shown and/or omit the operations shown, and the scope of the present disclosure is not limited thereto. The map data fusion method 300 may be considered as an extension of the map data fusion method 200.

At block 302, the computing device 110 acquires first map data. According to one or more embodiments of the present disclosure, the first map data includes a first set of three-dimensional coordinate points and a first feature descriptor set associated with the first set of three-dimensional coordinate points. The specific content of block 302 is the same as that of block 202, so details are not repeated here.

At block 304, the computing device 110 acquires second map data. According to one or more embodiments of the present disclosure, the second map data includes a second set of three-dimensional coordinate points and a second feature descriptor set associated with the second set of three-dimensional coordinate points. The specific content of block 304 is the same as that of block 204, so details are not repeated here.

At block 306, the computing device 110 determines, based on the first feature descriptor set and the second feature descriptor set, a set of matching point pairs between the first set of three-dimensional coordinate points and the second set of three-dimensional coordinate points. The specific content of block 306 is the same as that of block 206, so details are not repeated here.

At block 308, the computing device 110 determines, based on the set of matching point pairs determined at block 306, a pose transformation matrix between the first map data and the second map data and a set of inlier matching point pairs in the set of matching point pairs by using a random sample consensus iterative closest point algorithm. The specific content of determining the pose transformation matrix in block 308 is the same as that of determining the pose transformation matrix in block 208, so details are not repeated here.

According to one or more embodiments of the present disclosure, when the set of inlier matching point pairs in the set of matching point pairs is determined by using the random sample consensus iterative closest point algorithm, an inlier threshold distance for determining inlier matching point pairs may be configured, and the computing device 110 may determine the distance between two feature descriptors corresponding to two three-dimensional coordinate points included in a matching point pair, and determine the matching point pair as an inlier matching point pair when the distance between the two feature descriptors is less than the inlier threshold distance.

According to some embodiments of the present disclosure, the inlier threshold distance may be equal to the first threshold distance described for block 206 of the map data fusion method 200.

According to one or more embodiments of the present disclosure, the inlier matching point pairs may be preliminarily regarded as correct point pairs, and the matching point pairs in the set of matching point pairs that do not belong to the set of inlier matching point pairs may be preliminarily regarded as abnormal point pairs.

At block 310, the computing device 110 fuses the first map data and the second map data into third map data based on the pose transformation matrix determined at block 308, where the third map data may include a third set of three-dimensional coordinate points and a third feature descriptor set associated with the third set of three-dimensional coordinate points. The specific content of block 310 is the same as that of block 210, so details are not repeated here.

At block 312, the computing device 110 determines a set of self-matching point pairs in the third set of three-dimensional coordinate points based on the third feature descriptor set included in the third map data.

According to one or more embodiments of the present disclosure, the computing device 110 may first, for a third three-dimensional coordinate point in the third set of three-dimensional coordinate points, based on the third feature descriptor set, determine a fourth feature descriptor closest to a third feature descriptor associated with the third three-dimensional coordinate point in the third set of three-dimensional coordinate points.

Then, the computing device 110 may determine whether the distance between the third feature descriptor and the fourth feature descriptor is less than a preset second threshold distance, and determine the point pair associated with the third feature descriptor and the fourth feature descriptor as a self-matching point pair in the set of self-matching point pairs when the distance between the third feature descriptor and the fourth feature descriptor is less than the preset second threshold distance.

According to one or more embodiments of the present disclosure, the third three-dimensional coordinate point in the third set of three-dimensional coordinate points may refer to any point in the third set of three-dimensional coordinate points. When determining the set of self-matching point pairs in the third set of three-dimensional coordinate points, the computing device 110 may, for each point in the third set of three-dimensional coordinate points, search for a matching three-dimensional coordinate point in the third set of three-dimensional coordinate points to form a self-matching point pair, and the self-matching point pairs formed for all points in the third set of three-dimensional coordinate points constitute the set of self-matching point pairs. In some embodiments, only a few points in the third set of three-dimensional coordinate points can form self-matching point pairs with other points in the third set of three-dimensional coordinate points.

At block 314, the computing device 110 determines whether a first self-matching point pair in the set of self-matching point pairs in the third set of three-dimensional coordinate points determined at block 312 belongs to the set of inlier matching point pairs determined at block 308. If the first self-matching point pair belongs to the set of inlier matching point pairs, the method 300 proceeds to block 316, otherwise, the method 300 proceeds to block 318.

According to one or more embodiments of the present disclosure, the first self-matching point pair in the set of self-matching point pairs may refer to any self-matching point pair in the set of self-matching point pairs, so the content involved in block 314 may include determining whether each self-matching point pair in the set of self-matching point pairs belongs to the set of inlier matching point pairs determined at block 308.

At block 316, the computing device 110 merges the first self-matching point pair as a merge point in the third set of three-dimensional coordinate points. According to one or more embodiments of the present disclosure, merging the first self-matching point pair into merge points is equivalent to deleting two three-dimensional coordinate points included in the first self-matching point pair from the third set of three-dimensional coordinate points, and adding the merge point formed by merging the first self-matching point pair to the third set of three-dimensional coordinate points. When the first self-matching point pair belongs to the set of inlier matching point pairs determined at block 308, it can be considered that the first self-matching point pair should actually be the same point in the third set of three-dimensional coordinate points after merging, so the first self-matching point pair can be merged to avoid close repeated points in the third set of three-dimensional coordinate points after merging.

According to some embodiments of the present disclosure, the computing device 110 may determine coordinates and a feature descriptor of the merge point by averaging the coordinates and feature descriptors of the two three-dimensional coordinate points included in the first self-matching point.

According to other embodiments of the present disclosure, the computing device 110 may determine the coordinates and feature descriptor of one of the two three-dimensional coordinate points included in the first self-matching point as the coordinates and feature descriptor of the merge point.

At block 318, the computing device 110 determines the distance between the feature descriptors of the two three-dimensional coordinate points included in the first self-matching point.

At block 320, the computing device 110 determines whether the distance between the feature descriptors of the two three-dimensional coordinate points included in the first self-matching point is greater than a preset third threshold distance. If the distance between the feature descriptors of the two three-dimensional coordinate points is greater than the preset third threshold distance, the method 300 proceeds to block 322, otherwise, the method 300 may not perform an operation or may further manually determine how to perform further processing. It should be understood that the third threshold distance is greater than the inlier threshold distance.

At block 322, the computing device 110 deletes the two three-dimensional coordinate points included in the first self-matching point pair from the third set of three-dimensional coordinate points. When the distance between the feature descriptors of the two three-dimensional coordinate points included in the first self-matching point is greater than the preset third threshold distance, it can be considered that the two three-dimensional coordinate points included in the first self-matching point pair are actually different three-dimensional coordinate points in the physical world, so the first self-matching point pair has an error. Therefore, in order to avoid erroneous influence of the points included in the first self-matching point on the third map data, the two three-dimensional coordinate points included in the first self-matching point pair may be deleted from the third set of three-dimensional coordinate points.

According to one or more embodiments of the present disclosure, blocks 318 and 320 may be optional blocks in the method 300, where the computing device may, when determining at block 314 that the first self-matching point pair does not belong to the set of inlier matching point pairs, proceed directly to block 322 to delete the two three-dimensional coordinate points included in the first self-matching point pair from the third set of three-dimensional coordinate points.

In the map data fusion method 300, according to one or more embodiments of the present disclosure, 80%, for example, of the three-dimensional coordinate points in the first set of three-dimensional coordinate points are fused into the second set of three-dimensional coordinate points, and the remaining 20% of the three-dimensional coordinate points are merged at block 316 or deleted at block 322, respectively.

The relevant contents of the map data fusion environment 100 in which the map data fusion method in some embodiments of the present disclosure can be implemented, the map data fusion method 200 according to an embodiment of the present disclosure, and the map data fusion method 300 according to an embodiment of the present disclosure are described above with reference to FIGS. 1 to 3. It should be understood that the above descriptions are for the purpose of better illustrating the contents described in the present disclosure, and are not intended to limit in any way.

It should be understood that the numbers and physical quantities of various components used in the above drawings of the present disclosure are only examples, and do not limit the protection scope of the present disclosure. The above numbers and magnitudes can be arbitrarily configured as required without affecting the normal implementation of the embodiments of the present disclosure.

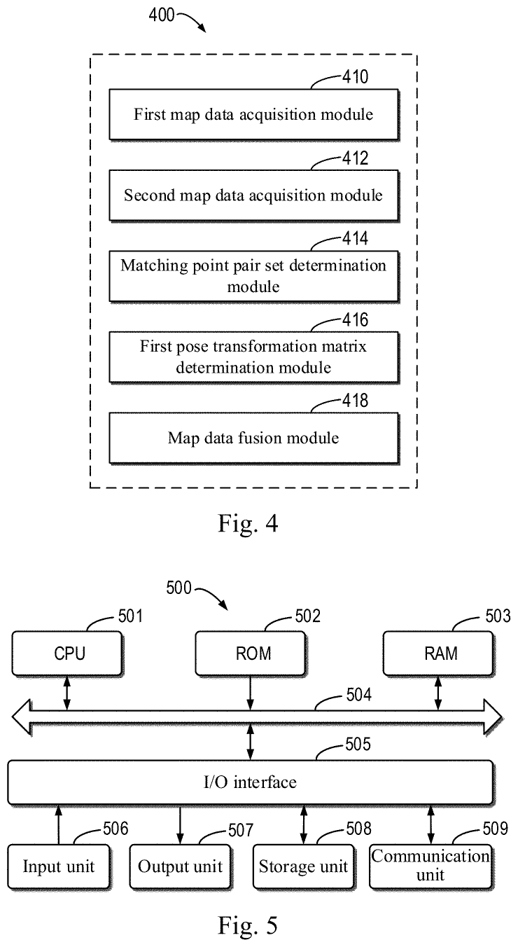

The details of the map data fusion method 200 and the map data fusion method 300 according to the embodiments of the present disclosure are described above with reference to FIGS. 1 to 3. Hereinafter, each module in a map data fusion apparatus will be described with reference to FIG. 4.

FIG. 4 is a schematic block diagram of a map data fusion apparatus 400 according to an embodiment of the present disclosure. As shown in FIG. 4, the map data fusion apparatus 400 may include: a first map data acquisition module 410, configured to acquire first map data, the first map data including a first set of three-dimensional coordinate points and a first feature descriptor set associated with the first set of three-dimensional coordinate points; a second map data acquisition module 412, configured to acquire second map data, the second map data including a second set of three-dimensional coordinate points and a second feature descriptor set associated with the second set of three-dimensional coordinate points, and the first map data and the second map data being for the same map; a matching point pair set determination module 414, configured to determine, based on the first feature descriptor set and the second feature descriptor set, a set of matching point pairs between the first set of three-dimensional coordinate points and the second set of three-dimensional coordinate points; a first pose transformation matrix determination module 416, configured to determine a pose transformation matrix between the first map data and the second map data based on the set of matching point pairs; and a map data fusion module 418, configured to fuse the first map data and the second map data into third map data based on the pose transformation matrix.

In one or more embodiments, the first map data acquisition module 410 includes: a captured image set acquisition module (not shown), configured to acquire a first captured image set; a feature extraction module (not shown), configured to perform feature extraction on the first captured image set to obtain a first feature point set, the first feature point set having the first feature descriptor set; and a first set determination module (not shown), configured to determine the first set of three-dimensional coordinate points based on the first feature point set.

In one or more embodiments, the matching point pair set determination module 414 includes: a first feature descriptor determination module (not shown), configured to, for a first three-dimensional coordinate point in the first set of three-dimensional coordinate points, based on a first feature descriptor associated with the first three-dimensional coordinate point in the first feature descriptor set and the second feature descriptor set, determine a second feature descriptor closest to the first feature descriptor in the second set of three-dimensional coordinate points; and a matching point pair determination module (not shown), configured to, if the distance between the first feature descriptor and the second feature descriptor is less than a first threshold distance, determine the point pair associated with the first feature descriptor and the second feature descriptor as a matching point pair in the set of matching point pairs.

In one or more embodiments, wherein the first pose transformation matrix determination module 416 includes: a second pose transformation matrix determination module (not shown), configured to determine the pose transformation matrix by using a random sample consensus iterative closest point algorithm.

In one or more embodiments, the map data fusion apparatus 400 further includes: an inlier matching point pair set determination module (not shown), configured to determine a set of inlier matching point pairs in the set of matching point pairs by using the random sample consensus iterative closest point algorithm.

In one or more embodiments, the third map data includes a third set of three-dimensional coordinate points and a third feature descriptor set associated with the third set of three-dimensional coordinate points, and the map data fusion apparatus 400 further includes: a self-matching point pair set determination module (not shown), configured to determine a set of self-matching point pairs in the third set of three-dimensional coordinate points based on the third feature descriptor set; and a self-matching point pair merging module (not shown), configured to, for a first self-matching point pair in the set of self-matching point pairs, if the first self-matching point pair belongs to the set of inlier matching point pairs, merge the first self-matching point pair as a merge point in the third set of three-dimensional coordinate points.

In one or more embodiments, the self-matching point pair set determination module includes: a second feature descriptor determination module (not shown), configured to, for a third three-dimensional coordinate point in the third set of three-dimensional coordinate points, based on the third feature descriptor set, determine a fourth feature descriptor closest to a third feature descriptor associated with the third three-dimensional coordinate point in the third set of three-dimensional coordinate points; and a self-matching point pair determination module (not shown), configured to, if the distance between the third feature descriptor and the fourth feature descriptor is less than a second threshold distance, determine the point pair associated with the third feature descriptor and the fourth feature descriptor as a self-matching point pair in the set of self-matching point pairs.

In one or more embodiments, the self-matching point pair merging module includes: a first coordinate and feature descriptor determination module (not shown), configured to determine coordinates and a feature descriptor of the merge point by averaging the coordinates and feature descriptors of the two three-dimensional coordinate points included in the first self-matching point.

In one or more embodiments, the self-matching point pair merging module includes: a second coordinate and feature descriptor determination module (not shown), configured to determine the coordinates and feature descriptor of one of the two three-dimensional coordinate points included in the first self-matching point as the coordinates and feature descriptor of the merge point.

In one or more embodiments, the map data fusion apparatus 400 further includes: a feature descriptor distance determination module (not shown), configured to, if the first self-matching point pair does not belong to the set of inlier matching point pairs, determine the distance between the feature descriptors of the two three-dimensional coordinate points included in the first self-matching point; and a point deletion module (not shown), configured to, if the distance is greater than a third threshold distance, delete the two three-dimensional coordinate points included in the first self-matching point pair from the third set of three-dimensional coordinate points.

From the above descriptions with reference to FIGS. 1 to 4, the technical solutions according to the embodiments of the present disclosure have many advantages over the traditional solutions. For example, using the technical solution of the method, map data can be quickly fused without mass computing resources, so that not only can computing resources be saved, but also user experience of users who need to use the fused map data can be improved.

According to the embodiments of the present disclosure, an electronic device, a computer-readable storage medium and a computer program product are further provided.

FIG. 5 shows a schematic block diagram of an exemplary electronic device 500 that can be used to implement the embodiments of the present disclosure. For example, the computing device 110 shown in FIG. 1 and the map data fusion apparatus 400 shown in FIG. 4 may be implemented by the electronic device 500. The electronic device is intended to represent various forms of digital computers, such as a laptop, a desktop, a worktable, a personal digital assistant, a server, a blade server, a mainframe computer, and other suitable computers. The electronic device may also represent various forms of mobile devices, such as a personal digital assistant, a cellular phone, a smart phone, a wearable device, and other similar computing devices. The components shown herein, their connections and relationships, and their functions are by way of example only, and are not intended to limit implementations of the present disclosure described and/or claimed herein.

As shown in FIG. 5, the device 500 includes a computation unit 501, which may execute various appropriate actions and processes in accordance with a computer program stored in a read-only memory (ROM) 502 or a computer program loaded into a random access memory (RAM) 503 from a storage unit 508. The RAM 503 also stores various programs and data required by operations of the device 500. The computation unit 501, the ROM 502 and the RAM 503 are connected to each other through a bus 504. An input/output (I/O) interface 505 is also connected to the bus 504.

The following components in the device 500 are connected to the I/O interface 505: an input unit 506, for example, a keyboard and a mouse; an output unit 507, for example, various types of displays and a speaker; a storage device 508, for example, a magnetic disk and an optical disk; and a communication unit 509, for example, a network card, a modem, a wireless communication transceiver. The communication unit 509 allows the device 500 to exchange information/data with an other device through a computer network such as the Internet and/or various telecommunication networks.

The computation unit 501 may be various general-purpose and/or special-purpose processing assemblies having processing and computing capabilities. Some examples of the computation unit 501 include, but not limited to, a central processing unit (CPU), a graphics processing unit (GPU), various dedicated artificial intelligence (AI) computing chips, various processors that run a machine learning model algorithm, a digital signal processor (DSP), any appropriate processor, controller and microcontroller, etc. The computation unit 501 performs the various methods and processes described above, for example, the map data fusion method 200 and 300. For example, in some embodiments, the map data fusion method 200 and 300 may be implemented as a computer software program, which is tangibly included in a machine readable medium, for example, the storage device 508. In some embodiments, part or all of the computer program may be loaded into and/or installed on the device 500 via the ROM 502 and/or the communication unit 509. When the computer program is loaded into the RAM 503 and executed by the computation unit 501, one or more steps of the above map data fusion method 200 and 300 may be performed. Alternatively, in other embodiments, the computation unit 501 may be configured to perform the map data fusion method 200 and 300 through any other appropriate approach (e.g., by means of firmware).

The various implementations of the systems and technologies described herein may be implemented in a digital electronic circuit system, an integrated circuit system, a field programmable gate array (FPGA), an application specific integrated circuit (ASIC), an application specific standard product (ASSP), a system-on-chip (SOC), a complex programmable logic device (CPLD), computer hardware, firmware, software and/or combinations thereof. The various implementations may include: being implemented in one or more computer programs, where the one or more computer programs may be executed and/or interpreted on a programmable system including at least one programmable processor, and the programmable processor may be a particular-purpose or general-purpose programmable processor, which may receive data and instructions from a storage system, at least one input device and at least one output device, and send the data and instructions to the storage system, the at least one input device and the at least one output device.

Program codes used to implement the method of embodiments of the present disclosure may be written in any combination of one or more programming languages. These program codes may be provided to a processor or controller of a general-purpose computer, particular-purpose computer or other programmable data processing apparatus, so that the program codes, when executed by the processor or the controller, cause the functions or operations specified in the flowcharts and/or block diagrams to be implemented. These program codes may be executed entirely on a machine, partly on the machine, partly on the machine as a stand-alone software package and partly on a remote machine, or entirely on the remote machine or a server.

In the context of the present disclosure, the machine-readable medium may be a tangible medium that may include or store a program for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any appropriate combination thereof. A more particular example of the machine-readable storage medium may include an electronic connection based on one or more lines, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination thereof.

To provide interaction with a user, the systems and technologies described herein may be implemented on a computer having: a display device (such as a CRT (cathode ray tube) or LCD (liquid crystal display) monitor) for displaying information to the user; and a keyboard and a pointing device (such as a mouse or a trackball) through which the user may provide input to the computer. Other types of devices may also be used to provide interaction with the user. For example, the feedback provided to the user may be any form of sensory feedback (such as visual feedback, auditory feedback or tactile feedback); and input from the user may be received in any form, including acoustic input, speech input or tactile input.

The systems and technologies described herein may be implemented in: a computing system including a background component (such as a data server), or a computing system including a middleware component (such as an application server), or a computing system including a front-end component (such as a user computer having a graphical user interface or a web browser through which the user may interact with the implementations of the systems and technologies described herein), or a computing system including any combination of such background component, middleware component or front-end component. The components of the systems may be interconnected by any form or medium of digital data communication (such as a communication network). Examples of the communication network include a local area network (LAN), a wide area network (WAN), and the Internet.

A computer system may include a client and a server. The client and the server are generally remote from each other, and generally interact with each other through the communication network. A relationship between the client and the server is generated by computer programs running on a corresponding computer and having a client-server relationship with each other.

It should be appreciated that the steps of reordering, adding or deleting may be executed using the various forms shown above. For example, the steps described in embodiments of the present disclosure may be executed in parallel or sequentially or in a different order, so long as the expected results of the technical schemas provided in embodiments of the present disclosure may be realized, and no limitation is imposed herein.

The above particular implementations are not intended to limit the scope of the present disclosure. It should be appreciated by those skilled in the art that various modifications, combinations, sub-combinations, and substitutions may be made depending on design requirements and other factors. Any modification, equivalent and modification that fall within the spirit and principles of the present disclosure are intended to be included within the scope of the present disclosure.

What is claimed is:

1. A map data fusion method, comprising:
acquiring first map data, the first map data comprising a first set of three-dimensional coordinate points and a first feature descriptor set associated with the first set of three-dimensional coordinate points;
acquiring second map data, the second map data comprising a second set of three-dimensional coordinate points and a second feature descriptor set associated with the second set of three-dimensional coordinate points, and the first map data and the second map data being for the same map;
determining, based on the first feature descriptor set and the second feature descriptor set, a set of matching point pairs between the first set of three-dimensional coordinate points and the second set of three-dimensional coordinate points;
determining a pose transformation matrix between the first map data and the second map data based on the set of matching point pairs; and
fusing the first map data and the second map data into third map data based on the pose transformation matrix.

2. The method according to claim 1, wherein acquiring the first map data comprises:
acquiring a first captured image set;
performing feature extraction on the first captured image set to obtain a first feature point set, the first feature point set having the first feature descriptor set; and
determining the first set of three-dimensional coordinate points based on the first feature point set.

3. The method according to claim 1, wherein determining the set of matching point pairs comprises:
for a first three-dimensional coordinate point in the first set of three-dimensional coordinate points, based on a first feature descriptor associated with the first three-dimensional coordinate point in the first feature descriptor set and the second feature descriptor set, determining a second feature descriptor closest to the first feature descriptor in the second set of three-dimensional coordinate points; and
if a distance between the first feature descriptor and the second feature descriptor is less than a first threshold distance, determining a point pair associated with the first feature descriptor and the second feature descriptor as a matching point pair in the set of matching point pairs.

4. The method according to claim 1, wherein determining the pose transformation matrix comprises:
determining the pose transformation matrix by using a random sample consensus iterative closest point algorithm.

5. The method according to claim 4, further comprising:
determining a set of inlier matching point pairs in the set of matching point pairs by using the random sample consensus iterative closest point algorithm.

6. The method according to claim 5, wherein the third map data comprises a third set of three-dimensional coordinate points and a third feature descriptor set associated with the third set of three-dimensional coordinate points, and the method further comprises:
determining a set of self-matching point pairs in the third set of three-dimensional coordinate points based on the third feature descriptor set; and
for a first self-matching point pair in the set of self-matching point pairs, if the first self-matching point pair belongs to the set of inlier matching point pairs, merging the first self-matching point pair as a merge point in the third set of three-dimensional coordinate points.

7. The method according to claim 6, wherein determining the set of self-matching point pairs comprises:
for a third three-dimensional coordinate point in the third set of three-dimensional coordinate points, based on the third feature descriptor set, determining a fourth feature descriptor closest to a third feature descriptor associated with the third three-dimensional coordinate point in the third set of three-dimensional coordinate points; and
if a distance between the third feature descriptor and the fourth feature descriptor is less than a second threshold distance, determining a point pair associated with the third feature descriptor and the fourth feature descriptor as a self-matching point pair in the set of self-matching point pairs.

8. The method according to claim 6, wherein merging the first self-matching point pair as the merge point in the third set of three-dimensional coordinate points comprises:
determining coordinates and a feature descriptor of the merge point by averaging the coordinates and feature descriptors of the two three-dimensional coordinate points included in the first self-matching point pair.

9. The method according to claim 6, wherein merging the first self-matching point pair as the merge point in the third set of three-dimensional coordinate points comprises:
determining the coordinates and feature descriptor of one of the two three-dimensional coordinate points included in the first self-matching point pair as the coordinates and feature descriptor of the merge point.

10. The method according to claim 6, further comprising:
if the first self-matching point pair does not belong to the set of inlier matching point pairs, determining a distance between the feature descriptors of the two three-dimensional coordinate points included in the first self-matching point pair; and
if the distance is greater than a third threshold distance, deleting the two three-dimensional coordinate points included in the first self-matching point pair from the third set of three-dimensional coordinate points.

11. An electronic device, comprising:
at least one processor; and
a memory storing instructions executable by the at least one processor, the instructions, when executed by the at least one processor, cause the at least one processor to perform map data fusion operations comprising:
acquiring first map data, the first map data comprising a first set of three-dimensional coordinate points and a first feature descriptor set associated with the first set of three-dimensional coordinate points;
acquiring second map data, the second map data comprising a second set of three-dimensional coordinate points and a second feature descriptor set associated with the second set of three-dimensional coordinate points, and the first map data and the second map data being for the same map;
determining, based on the first feature descriptor set and the second feature descriptor set, a set of matching point pairs between the first set of three-dimensional coordinate points and the second set of three-dimensional coordinate points;
determining a pose transformation matrix between the first map data and the second map data based on the set of matching point pairs; and
fusing the first map data and the second map data into third map data based on the pose transformation matrix.

12. The device according to claim 11, wherein acquiring the first map data comprises:
acquiring a first captured image set;
performing feature extraction on the first captured image set to obtain a first feature point set, the first feature point set having the first feature descriptor set; and
determining the first set of three-dimensional coordinate points based on the first feature point set.

13. The device according to claim 11, wherein determining the set of matching point pairs comprises:
for a first three-dimensional coordinate point in the first set of three-dimensional coordinate points, based on a first feature descriptor associated with the first three-dimensional coordinate point in the first feature descriptor set and the second feature descriptor set, determining a second feature descriptor closest to the first feature descriptor in the second set of three-dimensional coordinate points; and
if a distance between the first feature descriptor and the second feature descriptor is less than a first threshold distance, determining a point pair associated with the first feature descriptor and the second feature descriptor as a matching point pair in the set of matching point pairs.

14. The device according to claim 11, wherein determining the pose transformation matrix comprises:
determining the pose transformation matrix by using a random sample consensus iterative closest point algorithm.

15. The device according to claim 14, wherein the operations further comprise:
determining a set of inlier matching point pairs in the set of matching point pairs by using the random sample consensus iterative closest point algorithm.

16. The device according to claim 15, wherein the third map data comprises a third set of three-dimensional coordinate points and a third feature descriptor set associated with the third set of three-dimensional coordinate points, and the operations further comprise:
determining a set of self-matching point pairs in the third set of three-dimensional coordinate points based on the third feature descriptor set; and
for a first self-matching point pair in the set of self-matching point pairs, if the first self-matching point pair belongs to the set of inlier matching point pairs, merging the first self-matching point pair as a merge point in the third set of three-dimensional coordinate points.

17. The device according to claim 16, wherein determining the set of self-matching point pairs comprises:
for a third three-dimensional coordinate point in the third set of three-dimensional coordinate points, based on the third feature descriptor set, determining a fourth feature descriptor closest to a third feature descriptor associated with the third three-dimensional coordinate point in the third set of three-dimensional coordinate points; and
if a distance between the third feature descriptor and the fourth feature descriptor is less than a second threshold distance, determining a point pair associated with the third feature descriptor and the fourth feature descriptor as a self-matching point pair in the set of self-matching point pairs.

18. The device according to claim 16, wherein merging the first self-matching point pair as the merge point in the third set of three-dimensional coordinate points comprises:
determining coordinates and a feature descriptor of the merge point by averaging the coordinates and feature descriptors of the two three-dimensional coordinate points included in the first self-matching point pair.

19. The device according to claim 16, wherein merging the first self-matching point pair as the merge point in the third set of three-dimensional coordinate points comprises:
determining the coordinates and feature descriptor of one of the two three-dimensional coordinate points included in the first self-matching point pair as the coordinates and feature descriptor of the merge point.

20. A non-transitory computer-readable storage medium storing computer instructions, wherein the computer instructions are used to cause a computer to perform map data fusion operations comprising:
acquiring first map data, the first map data comprising a first set of three-dimensional coordinate points and a first feature descriptor set associated with the first set of three-dimensional coordinate points;
acquiring second map data, the second map data comprising a second set of three-dimensional coordinate points and a second feature descriptor set associated with the second set of three-dimensional coordinate points, and the first map data and the second map data being for the same map;
determining, based on the first feature descriptor set and the second feature descriptor set, a set of matching point pairs between the first set of three-dimensional coordinate points and the second set of three-dimensional coordinate points;
determining a pose transformation matrix between the first map data and the second map data based on the set of matching point pairs; and
fusing the first map data and the second map data into third map data based on the pose transformation matrix.
